(19) United States
(12) Patent Application Publication
(10) Pub. No.: US 2026/0120393 A1
(43) Pub. Date: Apr. 30, 2026

(54) DATA PROCESSING METHOD, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Yongxin WANG, Shenzhen (CN)

(21) Appl. No.: 19/373,096

(22) Filed: Oct. 29, 2025

Related U.S. Application Data
(63) Continuation of application No. PCT/CN2024/109848, filed on Aug. 5, 2024.

(30) Foreign Application Priority Data
Oct. 11, 2023 (CN) 202311318924.1

(51) Int. Cl. G06T 15/40; G06T 1/60; G06T 15/00

(52) U.S. Cl. CPC G06T 15/40; G06T 1/60; G06T 15/005; G06T 2210/12; G06T 2210/56

(57) ABSTRACT

A data processing method performed by a computer device includes obtaining object data of a virtual object in a virtual scene. The object data indicates a plurality of triangle groups of the virtual object and bounding box information of the triangle groups. The plurality of triangle groups are obtained by grouping triangles on a surface of an object model of the virtual object. The bounding box information indicates coordinate positions of bounding boxes of the plurality of triangle groups. The method further includes performing occlusion detection on the bounding boxes based on the object data to determine one or more unoccluded triangle groups, and performing rendering processing on the one or more unoccluded triangle groups to obtain a scene image of the virtual scene.

### CROSS-REFERENCE TO RELATED APPLICATIONS

This application is a continuation of International Application No. PCT/CN2024/109848, filed on Aug. 5, 2024, which claims priority to Chinese Patent Application No. 202311318924.1, entitled “DATA PROCESSING METHOD, DEVICE, MEDIUM, AND PROGRAM PRODUCT” filed on Oct. 11, 2023, the entire contents of which are incorporated herein by reference.

### FIELD OF THE TECHNOLOGY

This application relates to the field of virtual world technologies, and in particular, to a data processing method, a device, a medium, and a program product.

### BACKGROUND OF THE DISCLOSURE

In an application program including a virtual scene, a virtual object in the virtual scene is generally rendered into a two-dimensional image, and the two-dimensional image obtained through rendering is displayed on a screen.

In the related art, when a scene image of the virtual scene is displayed, occlusion culling may be performed on a virtual object in the virtual scene, in other words, a virtual object that is completely occluded in the virtual scene in a current viewing angle is detected, and rendering and drawing are performed on a virtual object that is not occluded or that is not completely occluded.

However, the solutions in the foregoing related art have a poor effect on occlusion culling of the virtual object, thus affecting efficiency of image display.

### SUMMARY

In accordance with the disclosure, there is provided a data processing method performed by a computer device and including obtaining object data of a virtual object in a virtual scene. The object data indicates a plurality of triangle groups of the virtual object and bounding box information of the triangle groups. The plurality of triangle groups are obtained by grouping triangles on a surface of an object model of the virtual object. The bounding box information indicates coordinate positions of bounding boxes of the plurality of triangle groups. The method further includes performing occlusion detection on the bounding boxes based on the object data to determine one or more unoccluded triangle groups, and performing rendering processing on the one or more unoccluded triangle groups to obtain a scene image of the virtual scene.

Also in accordance with the disclosure, there is provided a computer device including a processor and a memory storing at least one computer instruction that, when executed by the processor, causes the computer device to obtain object data of a virtual object in a virtual scene. The object data indicates a plurality of triangle groups of the virtual object and bounding box information of the triangle groups. The plurality of triangle groups are obtained by grouping triangles on a surface of an object model of the virtual object. The bounding box information indicates coordinate positions of bounding boxes of the plurality of triangle groups. The at least one computer instruction, when executed by the processor, further causes the computer device to perform occlusion detection on the bounding boxes based on the object data to determine one or more unoccluded triangle groups, and perform rendering processing on the one or more unoccluded triangle groups to obtain a scene image of the virtual scene.

Also in accordance with the disclosure, there is provided a data processing method including obtaining triangles on a surface of an object model of a virtual object, grouping the triangles into a plurality of triangle groups, generating bounding box information of the plurality of triangle groups that indicates coordinate positions of bounding boxes of the plurality of triangle groups, and generating object data of the virtual object based on the plurality of triangle groups and the bounding box information. The object data is to be used by a display device to perform occlusion detection on the bounding boxes to determine one or more unoccluded triangle groups and perform rendering processing on the one or more unoccluded triangle groups to obtain a scene image of a virtual scene.

### BRIEF DESCRIPTION OF THE DRAWINGS

FIG. 1 is a structural block diagram of a computer system according to an exemplary embodiment of this application.

FIG. 2 is a flowchart of a data processing method according to this application.

FIG. 3 is a flowchart of a data processing method according to this application.

FIG. 4 is a flowchart of a data processing method according to this application.

FIG. 5 is a framework diagram showing an offline pre-computation process according to this application.

FIG. 6 is a framework diagram showing a runtime processing process according to this application.

FIG. 7 is an effect diagram of triangles after grouping.

FIG. 8 is a schematic diagram showing a bounding box algorithm process.

FIG. 9 is a schematic diagram showing clustering of triangle clusters according to this application.

FIG. 10 is a schematic diagram showing splitting optimization of a large triangle cluster according to this application.

FIG. 11 is a schematic diagram showing combination optimization of small triangle clusters according to this application.

FIG. 12 is a diagram showing an occlusion clipping effect according to this application.

FIG. 13 is a schematic diagram showing an occlusion mark according to this application.

FIG. 14 is a schematic diagram showing batch submission for rendering according to this application.

FIG. 15 is a block diagram of a data processing apparatus according to an embodiment of this application.

FIG. 16 is a block diagram of a data processing apparatus according to an embodiment of this application.

FIG. 17 is a structural block diagram of a computer device according to an exemplary embodiment of this application.

### DESCRIPTION OF EMBODIMENTS

User information (including but not limited to user equipment information, user personal information, and the like) and data (including but not limited to data for analysis, stored data, displayed data, and the like) involved in this application are all information and data authorized by a user or fully authorized by all parties, and collection, use, and processing of related data need to comply with related laws, regulations, and standards of related countries and regions. For example, object behaviors such as an attack operation involved in this application are all obtained under full authorization.

For ease of understanding, some nouns involved in this application are explained below.

(1) Virtual scene: The virtual scene is a virtual scene displayed (or provided) when an application program is run on a terminal. The virtual scene may be a simulated environment scene of a real world, or may be a semi-simulated and semi-fictional three-dimensional environment scene, or may be an entirely fictional three-dimensional environment scene. The virtual scene may be any one of a two-dimensional virtual scene, a 2.5-dimensional virtual scene, and a three-dimensional virtual scene. The following embodiments are described by using an example in which the virtual scene is a three-dimensional virtual scene. However, this is not limited thereto. In some embodiments, the virtual scene may further be configured for a virtual scene battle between at least two virtual characters. In some embodiments, the virtual scene may further be configured for battling between at least two virtual characters by using virtual items. In some embodiments, the virtual scene may further be configured for battling between at least two virtual characters by using virtual items within a target area range, and the target area range continuously decreases over time in the virtual scene.

The virtual scene is generally generated by an application program in a computer device such as a terminal and displayed based on hardware (for example, a screen) in the terminal. The terminal may be a mobile terminal such as a smartphone, a tablet computer, or an e-book reader. Alternatively, the terminal may be a personal computer device such as a notebook computer or a stationary computer.

(2) Homogeneous coordinate: The homogeneous coordinate is a coordinate representation method used in geometry, computer graphics, and many other fields. In a homogeneous coordinate system, a point in an n-dimensional space is represented by using a point in an (n+1)-dimensional space. For example, in a three-dimensional space, a point is generally represented by three coordinates [x, y, z]^{T}, but in the homogeneous coordinate, the point is represented by four coordinates [x, y, z, w]^{T}, where w is the homogeneous coordinate. A main advantage thereof is that a matrix is allowed to be configured for representing and processing affine transformation (for example, translation, rotation, and scaling) and perspective projection. In a non-homogeneous coordinate, translation cannot be represented through matrix multiplication, which makes the combination and application of transformations more complex. However, in the homogeneous coordinate, all these transformations may be represented through matrix multiplication, which makes the combination and application of the transformations simpler. In this specification, all coordinates that use a transformation matrix to perform coordinate space transformation are homogeneous coordinates.

(3) Model matrix (M matrix): The matrix describes a position, a direction, and a size of a three-dimensional model in the world and is responsible for converting a coordinate from a local space (alternatively referred to as an object space) to a world space. In other words, after a coordinate value in the local space is multiplied by the M matrix, a corresponding coordinate in the world space may be obtained.

(4) View matrix (V matrix): The matrix describes a position and a direction of a camera (or an observer) in the world and is responsible for converting a coordinate from the world space to a view space (also referred to as a camera space). In other words, after a coordinate value in the world space is multiplied by the V matrix, a corresponding coordinate in the view space may be obtained.

(5) Projection matrix (P matrix): The matrix is responsible for defining how to map a 3D world to a 2D screen and convert a coordinate from the view space to a clipping space of the screen. In other words, after a coordinate value in the view space is multiplied by the P matrix, a corresponding coordinate in the clipping space may be obtained.

(6) Scene depth (SceneDepth): The scene depth refers to depth information of each pixel in a frame buffer after an object in a scene is rendered and drawn in a rendering process, i.e., distance information from the pixel to a camera.

(7) Triangle cluster (Cluster): The triangle cluster is a set formed by triangles on surfaces of a group of virtual object (for example, virtual character) models, and identifies an area of an object model.

(8) Single-frame bounding box of a triangle cluster: The single-frame bounding box of the triangle cluster is bounding box data corresponding to a key frame of an action of a virtual object in an area of an object model identified by the triangle cluster.

(9) Dynamic bounding box of a triangle cluster: The triangle cluster dynamic bounding box is a bounding box corresponding to all key frames of actions of a virtual object in an area of an object model identified by the triangle cluster.

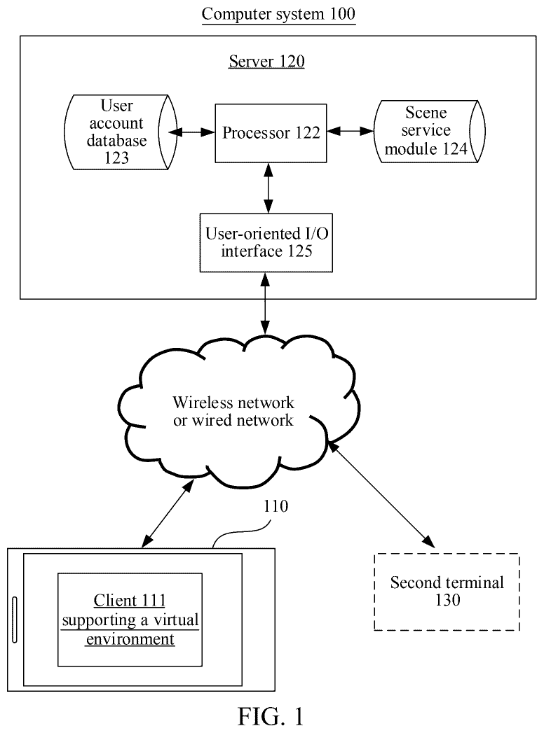

FIG. 1 shows a structural block diagram of a computer system according to an exemplary embodiment of this application. The computer system 100 includes: a first terminal 110 and a server 120.

A client 111 supporting a virtual scene is installed and run on the first terminal 110. When the first terminal runs the client 111, a user interface of the client 111 is displayed on a screen of the first terminal 110.

A device type of the first terminal 110 may include: at least one of a smartphone, a tablet computer, an e-book reader, an MP3 player, an MP4 player, a laptop portable computer, or a desktop computer.

FIG. 1 shows only one first terminal, but a plurality of other first terminals may access the server 120 in different embodiments. In some embodiments, there are alternatively one or more second terminals 130 that correspond to a developer. A development and editing platform for the client supporting a virtual scene is installed on the second terminal 130. The developer may edit and update the client on the second terminal 130, and transmit an updated client installation package to the server 120 through a wired network or a wireless network. The first terminal 110 may download the client installation package from the server 120 to update the client.

The first terminal 110 and the second terminal 130 are connected to the server 120 through a wireless network or a wired network.

The server 120 includes at least one of one server, a plurality of servers, a cloud computing platform, or a virtualization center. The server 120 is configured to provide a backend service for a client supporting a three-dimensional virtual scene. In some embodiments, the server 120 is responsible for primary computing work, and the terminal is responsible for secondary computing work; or the server 120 is responsible for secondary computing work, and the terminal is responsible for primary computing work; or a distributed computing architecture is used between the server 120 and the terminal for collaborative computing.

In an exemplary example, the server 120 includes a processor 122, a user account database 123, a scene service module 124, and a user-oriented input/output interface (I/O interface) 125. The processor 122 is configured to load instructions stored in the server 120, and process data in the user account database 123 and the scene service module 124. The user account database 123 is configured to store data of user accounts used by the first terminal 110 and another terminal, for example, avatars of the user accounts, nicknames of the user accounts, battle effectiveness indexes of the user accounts, and service zones of the user accounts. The scene service module 124 is configured to provide a plurality of virtual scenes, for example, a 1V1 battle, a 3V3 battle, and a 5V5 battle, for a user to control a virtual object to explore/move. The user-oriented I/O interface 125 is configured to establish, through a wireless network or a wired network, communication between the first terminal 110 and/or another first terminal for data exchange.

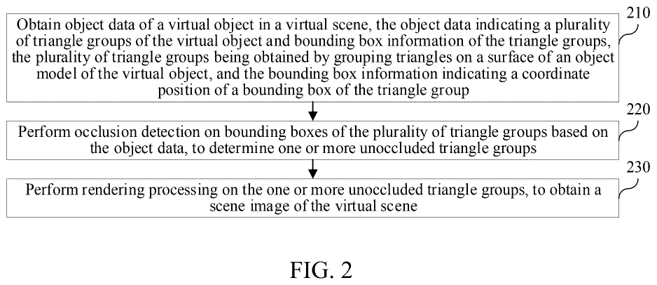

FIG. 2 shows a flowchart of a data processing method according to an exemplary embodiment of this application. The method may be performed by a computer device. The computer device may be the first terminal 110 in the system shown in FIG. 1, or the computer device may be the server 120 in the system shown in FIG. 1, or the computer device may include the first terminal 110 and the server 120 in the system shown in FIG. 1. The method includes the following operations.

Operation 210: Obtain object data of a virtual object in a virtual scene, the object data indicating a plurality of triangle groups of the virtual object and bounding box information of the triangle groups, the plurality of triangle groups being obtained by grouping triangles on a surface of an object model of the virtual object, and the bounding box information indicating a coordinate position of a bounding box of the triangle group.

In this embodiment of this application, the foregoing object data may be data generated and stored in a development process of the virtual object in the virtual scene. In a process of displaying a scene image of the virtual scene, a computer device may read the foregoing object data from a pre-stored object file of the scene image.

In this embodiment of this application, the surface of the object model may be formed by a mesh that is formed by triangles. In other words, an object model of a virtual object may be formed by splicing several triangles, each triangle represents a triangular plane of the surface of the object model, and a plurality of triangles may be spliced to represent a curved surface contour of the surface of the object model. Correspondingly, for an object model, a larger quantity of triangles forming the object model indicates a smaller area of a single triangle and a finer object model.

To accurately represent an object model by using a triangle mesh, each triangle in the object model has a respective attribute. For example, using an example in which the attribute of the triangle includes vertex coordinates, each triangle in the object model has respective vertex coordinates. The vertex coordinates may be coordinates of three vertexes of a triangle in an object space. The object space may also be referred to as a model space, and is a space used by a model manufacturer when an object model is created. In a three-dimensional coordinate system in the object space, a center of the object model is used as an origin. In some embodiments, the attribute of the foregoing triangle may further include another attribute other than the vertex coordinates, such as a normal direction.

The triangles in the object model of the virtual object may be grouped into a plurality of triangle groups in advance. A triangle group is also referred to as a triangle cluster, and corresponds to a plurality of triangles in an area of the object model of the virtual object.

For each triangle group of the virtual object, a bounding box of the triangle group may be preset. The bounding box of the triangle group may be automatically set by the computer device or may be manually set by a developer during a development process of the virtual object. In other words, the triangle group is in a one-to-one correspondence with the bounding box, and each triangle group corresponds to one bounding box. The bounding box of the triangle group may be a three-dimensional box with a specified shape and including all triangles in the triangle group. For example, the bounding box of the triangle group may be a three-dimensional box with a specified shape and a smallest volume and including all triangles in the triangle group.

For example, the specified shape may be a cuboid, a cube, a sphere, or the like.

The object data may include triangle group information of each of the plurality of triangle groups, and bounding box information of each triangle group.

The triangle group information may include coordinate information of a vertex of a triangle included in the triangle group, and triangle sequence information represented by an index of the vertex in the triangle included in the triangle group. Specifically, a triangle on the surface of the object model includes three vertexes, and adjacent triangles share some vertexes. Storage space is wasted if a triangle sequence is directly recorded by using a vertex data structure. Therefore, in this embodiment of this application, an index is provided for a vertex, a data structure of the index is much smaller than the vertex data structure. A triangle is recorded by using only the index of the vertex rather than the entire vertex data structure, so that storage space can be saved.

The bounding box information of the triangle group may include coordinate information of the bounding box. For example, the bounding box information of the triangle group may include coordinate information of at least two points on the bounding box.

Operation 220: Perform occlusion detection on the bounding boxes of the plurality of triangle groups based on the object data, to determine one or more unoccluded triangle groups.

The unoccluded triangle group may be a triangle group that is not completely occluded in the plurality of triangle groups. In other words, the triangle group that is not completely occluded may refer to a triangle group that is completely unoccluded and a triangle group that is partially occluded. In some embodiments, the triangle group that is partially occluded may be a triangle group in which a proportion of an occluded part to the entire triangle group is less than a proportion threshold.

Alternatively, the unoccluded triangle group may be a triangle group that is in the plurality of triangle groups and that is completely unoccluded.

In this embodiment of this application, after obtaining the object data, the computer device may perform occlusion detection on the bounding boxes of the plurality of triangle groups, to determine an unoccluded triangle group in the plurality of triangle groups.

The performing occlusion detection on the bounding boxes of the plurality of triangle groups based on the object data may mean emitting light to positions on a surface of the bounding box of the triangle group starting from a camera position at a current moment, and detecting whether the light is occluded before reaching a corresponding position on the surface of the bounding box, in other words, detecting whether the light collides with another object in the virtual scene before reaching the bounding box. If yes, it indicates that the corresponding position on the bounding box is occluded. Otherwise, it indicates that the corresponding position on the bounding box is not occluded.

The unoccluded triangle group in the plurality of triangle groups may be a triangle group that is in the plurality of triangle groups and whose corresponding bounding box is not completely occluded. For example, if all positions on a bounding box of one triangle group in the plurality of triangle groups are occluded, it is determined that the triangle group is occluded. If only a part of positions on a bounding box of one triangle group in the plurality of triangle groups is occluded, or all positions on the bounding box of the triangle group are not occluded, it is determined that the triangle group is not occluded.

Alternatively, the unoccluded triangle group in the plurality of triangle groups may be a triangle group that is in the plurality of triangle groups and in which a proportion of an area of an occluded position on a corresponding bounding box to a surface area of the corresponding bounding box is less than a proportion threshold. For example, if all positions on a bounding box of one triangle group in the plurality of triangle groups are occluded, it is determined that the triangle group is occluded. If only a part of positions on a bounding box of one triangle group in the plurality of triangle groups is occluded, and a proportion of an area of an occluded position to a surface area of the bounding box is greater than or equal to the proportion threshold, it is determined that the triangle group is occluded. For another example, if only a part of positions on a bounding box of one triangle group in the plurality of triangle groups is occluded, and a proportion of an area of an occluded position to a surface area of the bounding box is less than the proportion threshold, it is determined that the triangle group is not occluded. Alternatively, if all positions on the bounding box of the triangle group are not occluded, it is determined that the triangle group is not occluded.

The proportion threshold may be a threshold preset by a developer.

In the pre-generated object data, the coordinate information included in the triangle group information and the coordinate information included in the bounding box information may be the coordinate information of the vertex of the triangle in the triangle group and coordinate information of a position point on the bounding box respectively in the object space. When performing occlusion detection on the bounding boxes of the plurality of triangle groups, the computer device needs to perform occlusion detection in a space (for example, a world space, an observation space, or a clipping space) corresponding to the virtual scene. In this case, the computer device needs to first convert the coordinate information of the vertex of the triangle in the triangle group and the coordinate information of the position point on the bounding box respectively in the object space into coordinate information in the space corresponding to the virtual scene.

For ease of understanding, the foregoing several spaces are described below.

(1) Object space: The object space is also referred to as a model space/local space/modeling space, and is a coordinate system for defining a triangle of a model. Each model has its own coordinate system. For example, a geometric center of the model is used as an origin of the coordinate system, and position attributes of vertexes of the triangle in the model are coordinate values relative to the origin. The coordinate space may be referred to as the object space.

(2) World space: When a model is placed in a virtual scene (for example, a game world), a model matrix needs to be applied to the model. The matrix is for performing movement, rotation, and scaling transformation on the model, and a transformed model is placed in the world space at a particular angle, size, and position. There is no association relationship between object spaces of different objects, and the world space may provide a reference for positions of different objects in a scene.

(3) Observation space: The observation space is also referred to as a viewing angle space, and a coordinate system of this space is based on a camera. For example, a coordinate system is established using a position of the camera as an origin, an orientation of the camera as a positive direction of a Z-axis, a right side of the camera as a positive direction of an X-axis, and an upper side of the camera as a positive direction of a Y-axis. A coordinate space corresponding to the coordinate system is the observation space. A rendering pipeline is a series of processing processes for converting three-dimensional scene data into a two-dimensional image. However, in the world space, in addition to a model, there is a camera that observes the model. In this case, the image observed by the camera may be correctly obtained by defining the foregoing observation space, and computation may be convenient.

(4) Clipping space: The clipping space is a space in which a clipping operation is performed after a model in a world space is projected on a corresponding projection surface. A model of a virtual object in an entire virtual scene is located in an observation space, and a camera has a specific visual range. The range may be referred to as a viewing frustum. Objects inside the viewing frustum are visible to the camera (may be displayed on a screen), and objects outside the viewing frustum are invisible. To distinguish between visible objects and invisible objects, for vertexes of a triangle of the model in the observation space, a perspective projection matrix is applied, to transform the vertexes of the model to a new space, and the new space is the clipping space.

In a possible implementation, before performing occlusion detection on the bounding boxes of the plurality of triangle groups based on the object data to determine the unoccluded triangle group, instance-level occlusion detection may be first performed on the virtual object. In other words, whether the virtual object is occluded is first detected. If a detection result is that the virtual object is not occluded, occlusion detection is further performed on the bounding boxes of the plurality of triangle groups based on the object data, to determine the unoccluded triangle group.

For example, the computer device may obtain a bounding box of the virtual object, then detect whether position points on the bounding box of the virtual object are occluded. If the position points on the bounding box of the virtual object are not all occluded, or if only a part of positions on the bounding box of the virtual object is occluded, and a proportion of an area of the occluded position to a surface area of the bounding box is less than a proportion threshold, it is determined that the virtual object is not occluded. Further, occlusion detection is performed on the bounding boxes of the plurality of triangle groups based on the object data, to determine the unoccluded triangle group.

Operation 230: Perform rendering processing on the one or more unoccluded triangle groups, to obtain the scene image of the virtual scene.

The foregoing process of performing rendering processing on the one or more unoccluded triangle groups may mean calling an image application programming interface, such as a glDrawElecments command or a DrawIndexedPrimitive command, to transfer triangle group information corresponding to the unoccluded triangle group and other information required for rendering to a graphics processing unit (GPU), to indicate the GPU to perform a rendering operation. The other information needed for rendering may include information such as a color texture and a shadow texture.

The operation of calling the image application programming interface may also be referred to as a DrawCall operation.

In this embodiment of this application, the computer device may perform operation 210 to operation 230 when a quantity of virtual objects included in the picture of the virtual scene is greater than a threshold.

For example, when rendering and displaying the scene picture of the virtual scene, the computer device may first obtain a quantity of virtual objects within a field of view (for example, within the foregoing observation space) of a current camera, and perform operation 210 to operation 230 if the quantity of the virtual objects within the field of view of the current camera is greater than the threshold.

In other words, the solutions shown in the foregoing embodiment of this application may be applied to a large-scale virtual object rendering scenario, to reduce a processing and computation amount in a rendering and drawing process, and further improve efficiency of image display.

In conclusion, in the solutions shown in this embodiment of this application, the object data of the virtual object may indicate the plurality of triangle groups of the virtual object and the bounding box information of the triangle groups. In addition, one virtual object corresponds to the bounding boxes of the plurality of triangle groups. During occlusion culling, detection is performed per bounding box of the triangle group. A triangle group whose bounding box is occluded in the virtual object is culled, and rendering processing is performed on a triangle group whose bounding box is not occluded. In the foregoing solutions, the triangles in the object model of the virtual object are first grouped. For example, triangles in different model parts in the object model are grouped into different groups, and occlusion detection is performed on a bounding box of each group. Therefore, a granularity of occlusion detection on the object model may be split into a plurality of parts (specifically, split into a plurality of bounding boxes) in the object model from the entire object model, so that an occluded part of the virtual object can be culled, and rendering processing is performed on an unoccluded part, to implement occlusion detection at a finer granularity. This can improve an effect of occlusion culling on the virtual object in the virtual scene, reduce the processing and computation amount in the rendering and drawing process, and further improve the efficiency of image display.

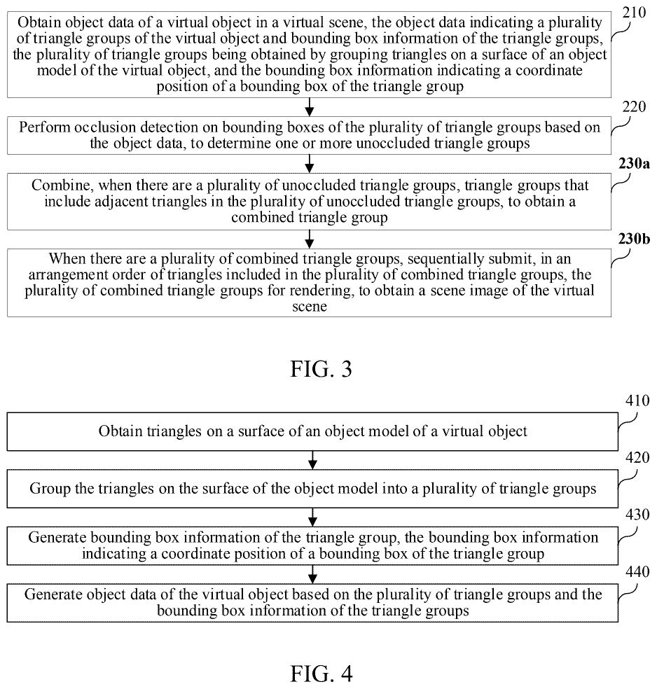

In some embodiments, triangles included in the triangle group are triangles that are adjacent after sorting based on a specified sorting algorithm. The specified sorting algorithm is an algorithm of sorting the triangles in the foregoing object model with a target of optimizing a vertex cache. Based on the embodiment in FIG. 2, FIG. 3 shows a flowchart of a data processing method according to an exemplary embodiment of this application. As shown in FIG. 3, operation 230 in the embodiment shown in FIG. 2 may be implemented as operation 230a and operation 230b.

Operation 230a: Combine, when there are a plurality of unoccluded triangle groups, triangle groups that include adjacent triangles in the plurality of unoccluded triangle groups, to obtain a combined triangle group.

For example, it is assumed that there are three triangle groups: a triangle group 1, a triangle group 2, and a triangle group 3. The triangle group 1 is {triangle 0, triangle 1, triangle 2}, the triangle group 2 is {triangle 3}, and the triangle group 3 is {triangle 4, triangle 5, triangle 6}. The triangle 0 to the triangle 6 are triangles that are renumbered after being sorted based on the specified sorting algorithm. In other words, in the triangle 0 to the triangle 6, two triangles with adjacent sequence numbers are also adjacent after sorting based on the specified sorting algorithm.

Assuming that after the occlusion detection in operation 220, it is determined that the triangle group 2 and the triangle group 3 are not occluded and are unoccluded triangle groups, the triangle group 2 and the triangle group 3 are combined into one combined triangle group.

In some embodiments, the combining triangle groups that include adjacent triangles in the plurality of unoccluded triangle groups to obtain the combined triangle group may mean adding triangles in triangle groups that meet a condition (namely, the included triangles are adjacent) to the combined triangle group based on an order obtained after sorting by the specified sorting algorithm.

For example, after the triangle group 2 and the triangle group 3 are combined into a combined triangle group, the combined triangle group is {triangle 3, triangle 4, triangle 5, triangle 6}. In other words, in the combined triangle group, an arrangement order of the triangles is also a result of sorting based on the specified sorting algorithm.

In this embodiment of this application, for a plurality of unoccluded triangle groups corresponding to the same virtual object, if triangles in two or more unoccluded triangle groups are adjacent (or consecutive in a sorting queue) after sorting based on the specified sorting algorithm, the triangles in the two or more unoccluded triangle groups are submitted together in the DrawCall operation. In this case, the two or more unoccluded triangle groups may be combined. Because the triangles included in the triangle group are adjacent triangles after sorting based on the specified sorting algorithm, after processing is performed based on the foregoing solution, in a process of rendering and drawing the triangles, the triangles may be submitted, in an arrangement order of the triangles, for rendering, to optimize the vertex cache to the greatest extent, and improve efficiency of hardware rendering.

Operation 230b: When there are a plurality of combined triangle groups, sequentially submit, in an arrangement order of triangles included in the plurality of combined triangle groups, the plurality of combined triangle groups for rendering, to obtain the scene image of the virtual scene.

For example, it is assumed that there are two combined triangle groups: a combined triangle group 1 and a combined triangle group 2. The combined triangle group 1 is {triangle 3, triangle 4, triangle 5, triangle 6}, and the combined triangle group 2 is {triangle 12, triangle 13, triangle 14}. When the two combined triangle groups are submitted for rendering and drawing, the combined triangle group 1 may be first submitted in a DrawCall operation, and then the combined triangle group 2 is submitted in a next DrawCall operation.

Based on the solutions shown in any one or more embodiments in the embodiments provided in this application, for example, based on the solutions shown in FIG. 2 or FIG. 3, in some embodiments, one triangle is bound to one or more bones in the object model, the virtual object has one or more action states, and the bounding box corresponding to the triangle group is a single bounding box of the triangle group in all action states of the virtual object.

That one triangle is bound to one or more bones may also be referred to as that one triangle is associated with one or more bones. An association relationship between the triangle and the bone may be completed by a developer (for example, an action artist or an action technical artist (TA)) in a development tool (for example, a digital content creation (DCC) tool).

In this embodiment of this application, for an object model, the object model may have a preset action. In a process in which the virtual object executes the action, a position of a triangle in the object model (herein referred to a position of the triangle in the object model in the object space, in other words, a position of the triangle/a vertex of the triangle relative to a root node of the object model) changes. Therefore, in this embodiment of this application, one bounding box may be set for one triangle group, and the bounding box may include positions of all triangles in the triangle group in all action states/some key action states of the virtual object. The action state may also be referred to as an action frame. In this case, when the virtual object is in different action states, the bounding box can include all triangles in the triangle group. In the foregoing solutions, when the virtual object has a plurality of different action states, only one bounding box needs to be preset for each triangle group. This can greatly reduce a data storage amount. In addition, in a rendering process, for the same triangle group, there is no need to consider a difference between bounding boxes in different action states, and a subsequent rendering operation can be performed by invoking the same bounding box, thereby reducing a computation amount in the rendering process and improving rendering efficiency.

Based on the solutions shown in any one or more embodiments in the embodiments provided in this application, for example, based on the solutions shown in FIG. 2 or FIG. 3, in some embodiments, one triangle is bound to one or more bones in the object model, the virtual object has one or more action states, and the bounding box corresponding to the triangle group includes a bounding box respectively corresponding to the triangle group in the one or more action states of the virtual object.

The performing occlusion detection on the bounding boxes of the plurality of triangle groups based on the object data to determine one or more unoccluded triangle groups includes:

performing, based on the object data, occlusion detection on the bounding boxes respectively corresponding to the plurality of triangle groups in a current action state of the virtual object, to determine the one or more unoccluded triangle groups.

In another possible implementation of this embodiment of this application, for one triangle group, one bounding box may be set corresponding to each action state of the virtual object. In other words, in different action states, the triangle group corresponds to different bounding boxes. Correspondingly, during subsequent image rendering and drawing, the computer device determines a current bounding box of the triangle group based on a current action state of the virtual object, and performs occlusion detection based on the current bounding box of the triangle group. Because in different action states, cases of occlusion of a model part corresponding to the triangle group may be different, and a volume of the bounding box of the triangle group in the current action state is generally smaller than a volume of a single bounding box of the triangle group in all action states of the virtual object, the bounding box of the triangle group in the current action state has higher accuracy than the single bounding box of the triangle group in all action states of the virtual object. Performing occlusion detection on the bounding box of the triangle group in the current action state can improve accuracy of occlusion detection, thereby improving accuracy of image rendering.

Based on the embodiment shown in FIG. 2 or FIG. 3, the object data involved in the embodiment may be generated in an offline stage. For a generation method of the object data in the foregoing embodiment shown in FIG. 2 or FIG. 3, refer to FIG. 4.

FIG. 4 shows a flowchart of a data processing method according to an exemplary embodiment of this application. The method may be performed by a computer device. The computer device may be the second terminal 130 in the system shown in FIG. 1. As shown in FIG. 4, the method includes the following operations.

Operation 410: Obtain triangles on a surface of an object model of a virtual object.

In this embodiment of this application, the triangles on the surface of the object model may be set by a developer when the developer develops the object model and stored in a file of the object model. In this embodiment of this application, the computer device may read related information of the triangles on the surface of the object model, for example, coordinates of vertexes of the triangles (or for example, coordinates of the vertexes of the triangles in an object space) from the file of the object model.

Operation 420: Group the triangles on the surface of the object model into a plurality of triangle groups.

In some embodiments, the grouping the triangles on the surface of the object model into a plurality of triangle groups includes:

sorting the triangles on the surface of the object model based on a specified sorting algorithm, the specified sorting algorithm being an algorithm of sorting the triangles in the object model with a target of optimizing a vertex cache; and grouping the triangles on the surface of the object model into the plurality of triangle groups based on an arrangement order of the triangles on the surface of the object model, the triangle groups including triangles that are adjacent after sorting.

The foregoing optimizing the vertex cache may mean being friendly to a hardware vertex cache (VertexCache). For example, a vertex hit rate of the hardware VertexCache may be improved during subsequent runtime computation.

For example, the specified sorting algorithm may be a linear velocity vertex cache optimization algorithm.

For example, the computer device sorts the triangles on the surface of the object model based on the linear velocity vertex cache optimization algorithm, renumbers the triangles based on the arrangement order of the triangles, and then groups the triangles into a plurality of triangle groups based on the arrangement order of the triangles. Each triangle group includes one triangle or a plurality of triangles with consecutive numbers.

Because the specified sorting algorithm is a sorting algorithm with the target of optimizing the vertex cache, the triangles are rearranged and grouped based on the specified sorting algorithm. In this way, when a DrawCall is subsequently submitted in a rendering and displaying process, the vertex cache may be optimized, the vertex hit rate of the hardware VertexCache is improved, and rendering efficiency is ensured.

In another possible implementation, the computer device may group the triangles on the surface of the object model in another manner. For example, the computer device may compute a model bounding box in the object space of the virtual object. The model bounding box completely includes the object model of the virtual object. Then, the computer device divides the model bounding box into a plurality of sub-bounding boxes, and groups a triangle that is on the surface of the object model and that is included in each sub-bounding box into one triangle group, to obtain the plurality of triangle groups.

The model bounding box may be a bounding box of a preset shape. For example, the model bounding box may be a sphere bounding box, a cube bounding box, or a cuboid bounding box.

The model bounding box may be a smallest external bounding box of the object model. For example, when the shape of the model bounding box is a sphere, the model bounding box is a smallest sphere bounding box that completely includes the object model. Alternatively, when the shape of the model bounding box is a cuboid, the model bounding box is a smallest cuboid bounding box that completely includes the object model.

For example, the model bounding box is a smallest cuboid bounding box that completely includes the object model is used. The computer device may evenly divide the cuboid bounding box into a plurality of parts, for example, evenly divide the cuboid bounding box into four sub-bounding boxes, and group a triangle that is on the surface of the object model and that is included in each sub-bounding box into one group, to obtain four triangle groups.

In some embodiments, one triangle is bound to one or more bones in the object model, and the grouping the triangles on the surface of the object model into the plurality of triangle groups based on the arrangement order of the triangles on the surface of the object model includes:

grouping the triangles on the surface of the object model into a plurality of candidate triangle groups based on the arrangement order of the triangles on the surface of the object model and the bones bound to the triangles on the surface of the object model; and performing specified processing on the plurality of candidate triangle groups, to obtain the plurality of triangle groups, the specified processing including at least one of combining processing or splitting processing.

In this embodiment of this application, a process of grouping the triangles on the surface of the object model into the plurality of candidate triangle groups based on the arrangement order of the triangles on the surface of the object model and the bones bound to the triangles on the surface of the object model may mean grouping, into the same candidate triangle group, triangles that are at consecutive positions after arrangement and that are bound to the same bone or bones close in positions in the triangles on the surface of the object model. Because the triangles on the surface of the object model are sorted with the target of optimizing the vertex cache, in the sorted triangles, triangles that are adjacent in the arrangement order may not be adjacent in position. After the candidate triangle groups are obtained through grouping based on the bones bound to the triangles, because both of two conditions: a partial arrangement order and binding to the same bone or bones close in positions need to be satisfied, distribution of quantities of triangles in the candidate triangle groups obtained through arrangement may be imbalanced. In other words, a quantity of triangles in some candidate triangle groups is relatively large, and a quantity of triangles in some candidate triangle groups may be relatively small.

Therefore, the computer device may further perform combining processing or splitting processing on the plurality of candidate triangles, to obtain a plurality of triangle groups. The combining processing or splitting processing may mean performing combining processing or splitting processing on two candidate triangle groups that include triangles adjacent in the arrangement order, to ensure that triangles in a combined triangle group are adjacent after sorting based on the specified sorting algorithm.

Because triangles corresponding to the same bone or bones close in positions are also adjacent or close in positions, according to the foregoing solutions, the triangles on the surface of the object model may be clustered based on positions, so that triangles included in each candidate triangle group are adjacent or close in positions. Positions of triangles in different candidate triangle groups are separated, so that subsequently obtained bounding boxes of the triangle groups does not overlap as much as possible. In addition, because combining processing or splitting processing is performed on the plurality of candidate triangle groups, it can be ensured that quantities of triangles included in the triangle groups are close. Therefore, sizes of the bounding boxes of the triangle groups can be as similar as possible. In other words, according to the foregoing solutions, triangle groups whose bounding boxes have similar sizes and that does not overlap as much as possible can be obtained through grouping, thereby ensuring a grouping effect of the triangle groups.

In this embodiment of this application, the computer device may further group, in the arrangement order of the triangles, the triangles on the surface of the object model in another manner. For example, the computer device evenly groups the triangles on the surface of the object model into a plurality of triangle groups based on the arrangement order of the triangles.

For example, a quantity N of triangle groups grouped from each object model is preset in the computer device. During grouping, the computer device first reads or counts a quantity M of the triangles on the surface of the object model, sorts the triangles on the surface of the object model based on a specified sorting algorithm, and groups every K consecutive triangles in the sorted triangles into a triangle group. K may be a result of rounding up or down M/N.

In some embodiments, the grouping the triangles on the surface of the object model into the plurality of candidate triangle groups based on the arrangement order of the triangles on the surface of the object model and the bones bound to the triangles on the surface of the object model includes:

obtaining bones respectively bound to a first triangle and a second triangle, the first triangle and the second triangle being two triangles adjacent in the arrangement order in the triangles on the surface of the object model; and adding the first triangle and the second triangle to the same candidate triangle group when the bones respectively bound to the first triangle and the second triangle are the same.

In this embodiment of this application, after sorting the triangles on the surface of the object model based on the specified sorting algorithm, the computer device may traverse every two triangles that are adjacent after sorting. If bones respectively bound to the two triangles are the same, the two triangles are grouped into the same candidate triangle group.

For example, it is assumed that after sorting based on the specified sorting algorithm, there are a plurality of triangles with consecutive numbers. It is assumed that the first four triangles are respectively a triangle 1, a triangle 2, a triangle 3, and a triangle 4. The computer device first detects bones respectively bound to the triangle 1 and the triangle 2, determines that the bones respectively bound to the triangle 1 and the triangle 2 are the same, and groups the triangle 1 and the triangle 2 into a candidate triangle group 1. Then, the computer device detects bones respectively bound to the triangle 2 and the triangle 3, determines that the bones respectively bound to the triangle 2 and the triangle 3 are also the same, and groups the triangle 3 into the candidate triangle group 1. Then, the computer device detects bones respectively bound to the triangle 3 and the triangle 4, and determines that the bones respectively bound to the triangle 3 and the triangle 4 are different. In this case, the computer device groups the triangle 4 into a new candidate triangle group 2. Then, the computer device detects whether bones respectively bound to the triangle 4 and a subsequent triangle are the same, and so on.

That the bones respectively bound to the first triangle and the second triangle are the same may mean that one or more bones bound to each of the first triangle and the second triangle are completely the same, or may mean that one or more bones bound to each of the first triangle and the second triangle are partially the same.

According to the solutions shown in the foregoing embodiment, a solution of determining a candidate triangle group by traversing triangles that are adjacent after sorting is provided, to ensure implementability of grouping the triangles on the surface of the object model into the plurality of candidate triangle groups based on the arrangement order of the triangles on the surface of the object model and the bones bound to the triangles on the surface of the object model. In addition, algorithm logic thereof is simple and easy to be implemented, so that consumption of computing resources can be reduced and computing efficiency can be ensured.

In this embodiment of this application, the computer device may further group, in another manner, the triangles on the surface of the object model based on the arrangement order of the triangles and the bones bound to the triangles. For example, the computer device may group a triangle corresponding to each bone in the object model into a triangle set, and then for each triangle set, group, into a candidate triangle group, triangles that are consecutive after sorting based on the specified sorting algorithm. In some embodiments, one triangle may be bound to one or more bones. Therefore, some triangles may be the same in triangle sets corresponding to different bones. In this case, before grouping triangles in a triangle set into a candidate triangle group, the computer device may first perform deduplication on triangles in each triangle set. For example, for any two triangle sets, the computer device may determine the same triangle therein (which may be referred to as a shared triangle of the two triangle sets), and then delete the shared triangle from the triangle set.

Based on the solutions shown in any one or more embodiments involving the candidate triangle groups in the embodiments provided in this application, in some embodiments, the performing specified processing on the plurality of candidate triangle groups, to obtain the plurality of triangle groups includes:
dividing a first candidate triangle group into two or more triangle groups when a quantity of triangles included in the first candidate triangle group is greater than a quantity threshold, the first candidate triangle group being one of the plurality of candidate triangle groups, and a quantity of triangles included in the triangle group being not greater than the quantity threshold; and
combining a second candidate triangle group and a third candidate triangle group when a sum of a quantity of triangles included in the second candidate triangle group and a quantity of triangles included in the third candidate triangle group is not greater than the quantity threshold, the second candidate triangle group and the third candidate triangle group being adjacent groups in the plurality of candidate triangle groups.

That the second candidate triangle group and the third candidate triangle group are adjacent groups in the plurality of candidate triangle groups means that a plurality of triangles included in the second candidate triangle group and the third candidate triangle group are a plurality of triangles that are adjacent after sorting based on the specified sorting algorithm.

The quantity threshold may be a value preset by a developer. For example, the developer selects a quantity threshold with optimal performance based on an experimental result.

Alternatively, the quantity threshold may be a quantity threshold computed by the computer device based on the quantity of the triangles on the surface of the object model and a preset maximum quantity of triangle groups. For example, the quantity threshold may be a result of rounding up or down after the quantity of the triangles on the surface of the object model divided by the preset maximum quantity of the triangle groups. The maximum quantity of triangle groups may be preset by the developer.

In this embodiment of this application, for a candidate triangle group in which a quantity of included triangles is greater than the quantity threshold, the computer device groups the triangles in the candidate triangle group into a plurality of triangle groups based on an arrangement order, to ensure that a quantity of triangles included in each triangle group does not exceed the quantity threshold. For example, the computer device groups first S triangles in the candidate triangle group into a triangle group based on the arrangement order of the triangles in the candidate triangle group, and removes the first S triangles from the candidate triangle group. If a quantity of remaining triangles in the candidate triangle group is still greater than the quantity threshold, the computer device continues to group first S triangles in the remaining triangles into a triangle group, and removes the first S triangles in the remaining triangles from the candidate triangle group, and so on, until a quantity of remaining triangles in the candidate triangle group is not greater than the quantity threshold. In this case, the candidate triangle group is used as a new triangle group, and a process of grouping the candidate triangle group ends.

According to the foregoing solutions, it can be ensured that a quantity of the triangles in each triangle group does not exceed a specific quantity threshold, to avoid a problem that a bounding box of one or more triangle groups is excessively large (if a bounding box of a triangle group is excessively large, in a rendering process, a DrawCall needs to be submitted because a part of the bounding box of the triangle group is highly probably not occluded), and ensure an effect of subsequent occlusion culling performed on the triangle group based on the bounding box of the triangle group.

In this embodiment of this application, for two adjacent candidate triangle groups each including a small quantity of triangles, the computer device may combine the two candidate triangle groups. Specifically, if a total quantity of triangles included in the two adjacent candidate triangle groups does not exceed the quantity threshold, the computer device may combine the triangles in the two candidate triangle groups into the same candidate triangle group.

According to the foregoing solutions, a situation in which a quantity of groups is large because a quantity of triangles included in each triangle group is excessively small can be avoided as much as possible. This reduces a quantity of triangle groups that need to be processed in a subsequent occlusion detection process, improves occlusion detection efficiency, and improves concurrent performance of a GPU during rendering (that is, more triangles can be processed in one DrawCall process).

Operation 430: Generate bounding box information of the triangle group, the bounding box information indicating a coordinate position of the bounding box of the triangle group.

The bounding box information includes coordinate information configured for representing the bounding box. Specifically, for example, the bounding box is a cuboid bounding box or a cube bounding box. The bounding box information may include coordinate values of two or more vertexes in the bounding box.

For example, the foregoing bounding box is a bounding box determined based on an axis-aligned bounding box (AABB) algorithm. The bounding box is a cuboid or a cube whose edges are separately parallel to three coordinate axes (an x-axis, a y-axis, and a z-axis). In this case, a position of the bounding box may be represented by using coordinates of two vertexes of the bounding box. Coordinate values of one of the vertexes are largest values (where a coordinate value of an x-axis coordinate, a coordinate value of a y-axis coordinate, and a coordinate value of a z-axis coordinate are all the largest) in coordinate values of points in the bounding box, and coordinate values of the other vertex are smallest values (where a coordinate value of an x-axis coordinate, a coordinate value of a y-axis coordinate, and a coordinate value of a z-axis coordinate are all the smallest) in the coordinate values of the points in the bounding box.

For another example, the bounding box is a sphere bounding box. The bounding box information may include center coordinates of the sphere bounding box and a radius of the sphere bounding box.

Based on the solutions shown in any one or more embodiments involving the triangle groups in the embodiments provided in this application, in some embodiments, the virtual object has one or more action states, and the generating the bounding box information of the triangle group includes:
generating a single piece of bounding box information of the triangle group in all action states of the virtual object; or
generating bounding box information respectively corresponding to the triangle group in the one or more action states of the virtual object.

In this embodiment of this application, for a virtual object having a plurality of action states, when generating bounding box information of one triangle group, the computer device may separately generate one bounding box corresponding to each action state, or corresponding to some action states (for example, some key action states, or some randomly determined action states) in the plurality of action states, to obtain a plurality of bounding boxes, then determine a single bounding box that completely includes the plurality of bounding boxes, and use bounding box information of the single bounding box as the bounding box information of the triangle group.

Alternatively, for the plurality of bounding boxes, the computer device may alternatively use generated bounding box information of each bounding box as the bounding box information of the triangle group, and bind each piece of bounding box information to a corresponding action state (for example, add an identifier of the corresponding action state to the bounding box information).

Operation 440: Generate object data of the virtual object based on the plurality of triangle groups and the bounding box information of the triangle groups.

In this embodiment of this application, the computer device may add triangle group information of the plurality of triangle groups and the bounding box information of the triangle groups to the object data of the virtual object, to generate the object data.

The object data is used by a display device to perform occlusion detection on the bounding boxes of the plurality of triangle groups, to determine one or more unoccluded triangle groups, and perform rendering processing on the one or more unoccluded triangle groups, to obtain a scene image of the virtual scene. The unoccluded triangle group is a triangle group that is not occluded and that is in the plurality of triangle groups.

In conclusion, in the solutions shown in this embodiment of this application, the object data of the virtual object may indicate the plurality of triangle groups of the virtual object and the bounding box information of the triangle groups. In addition, one virtual object corresponds to a plurality of bounding boxes of the triangle groups. During occlusion culling, detection is performed by using the bounding box of the triangle group as a unit. A triangle group in which the bounding box is occluded in the virtual object is culled, and rendering processing is performed on a triangle group in which the bounding box is not occluded, so as to cull an occluded part of the virtual object, and perform rendering processing on an unoccluded part. This can improve an effect of occlusion culling on the virtual object in the virtual scene, reduce a processing and computation amount in a rendering process, and further improve efficiency of image display.

The solutions shown in this embodiment of this application may be applied to a large-scale character rendering scenario. Based on the foregoing embodiments shown in FIG. 2 to FIG. 4, an overall framework of the foregoing embodiments of this application includes two parts: offline pre-computation and runtime processing. First, for a character action, a character triangle cluster and a dynamic bounding box of the triangle cluster are pre-computed offline and saved. Then, during running, clipping and culling at a character instance level and a triangle cluster level are performed based on a GPU. Finally, DrawCall information is integrated and submitted for rendering, to complete the entire rendering process.

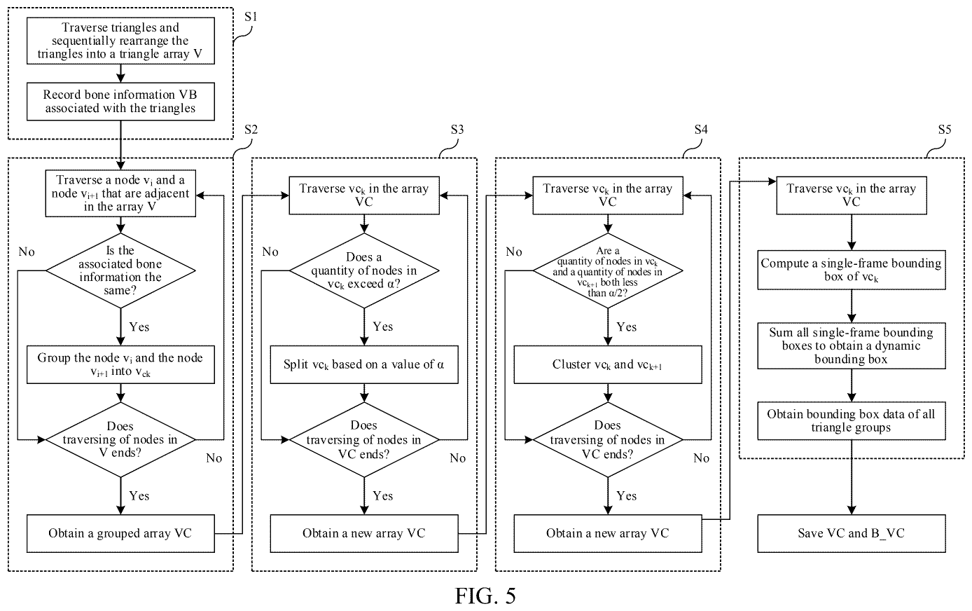

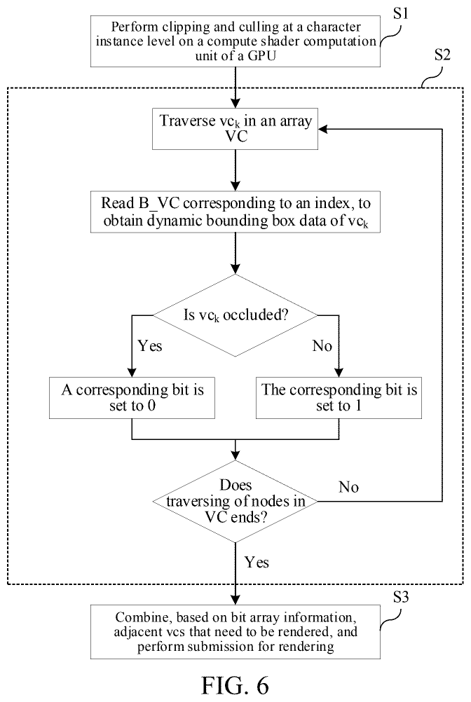

Refer to FIG. 5 and FIG. 6. FIG. 5 shows a framework diagram of an offline pre-computation process according to this application, and FIG. 6 shows a framework diagram of a runtime processing process according to this application. The following is shown in FIG. 5 and FIG. 6.

### 1. Offline Pre-computation Process

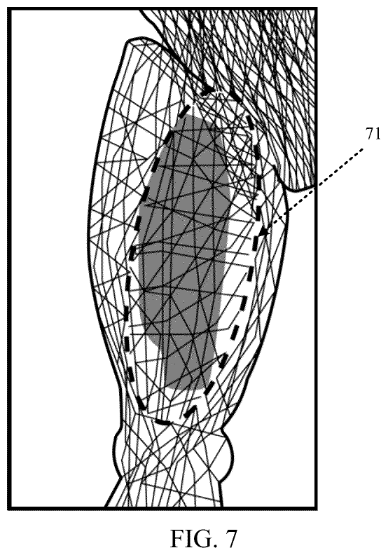

To more precisely and efficiently implement computation and culling processing on an occlusion relationship between a dynamic character and a scene and an occlusion relationship between dynamic characters, a triangle cluster generation based on bone algorithm is designed in this application. A main process thereof is first performing a triangle clustering process, to obtain a triangle cluster set of a character model. In this operation, the character model is divided into several small areas based on bone association information, each divided small area corresponds to a group of triangles, and the group of triangles is referred to as a triangle cluster. FIG. 7 is a effect diagram showing the state after triangule grouping. In FIG. 7, dark triangles in an area 71 are a triangle cluster.

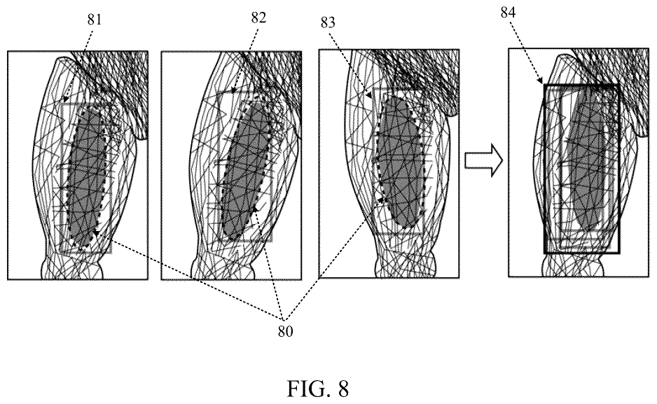

Next, dynamic bounding boxes of all triangle clusters of a character are computed. Assuming that a character action includes n key frames, for each triangle cluster, single-frame bounding boxes of the n key frames are separately computed, and then n single-frame bounding boxes are combined, to obtain a dynamic bounding box of the triangle cluster. In this algorithm, an AABB algorithm may be used. A schematic diagram of a process of the bounding box algorithm may be shown in FIG. 8. As shown in FIG. 8, for three different action states of a limb part, in the three different action states, positions of a triangle cluster (to be specific, triangles in an elliptic dashed-line box 80 in the figure) in the limb part are different. It is assumed that single-frame bounding boxes in the left three key frames are a bounding box 81, a bounding box 82, and a bounding box 83, and a finally obtained dynamic bounding box is a bounding box 84. The bounding box 84 includes the bounding box 81, the bounding box 82, and the bounding box 83.

The bounding box in FIG. 8 is in a two-dimensional form. Actually, because the model is three-dimensional, the bounding box computed herein is also a three-dimensional bounding box.

As shown in FIG. 5, a specific algorithm process of the foregoing offline pre-computation is described as follows:

Operation S1: Obtain character triangles, bones, and triangle-bone association information: traverse and record all character triangles, and invoke a linear velocity vertex cache optimization algorithm to sequentially rearrange vertex data, and arrange the vertex data as a vertex array friendly to a hardware VertexCache, to reduce computational overheads and improve performance; and record all bone information associated with each triangle as well. One triangle may be associated with a plurality of pieces of bone information. Assuming that a quantity of character triangles is m, and the triangle is represented by v, triangle array V={vi, i=0, 1, . . . , m−1}. Assuming that a quantity of bones is r, and the bone is represented by b, bone array B={bi, i=0, 1, . . . , r−1}. A bone array associated with each triangle vi is Bi, where Bi={bj, bj∈B and bj is associated with vi}, and all bone information associated with the triangles is VB, where VB={(vi, Bi), i=0, 1, . . . , m−1}.

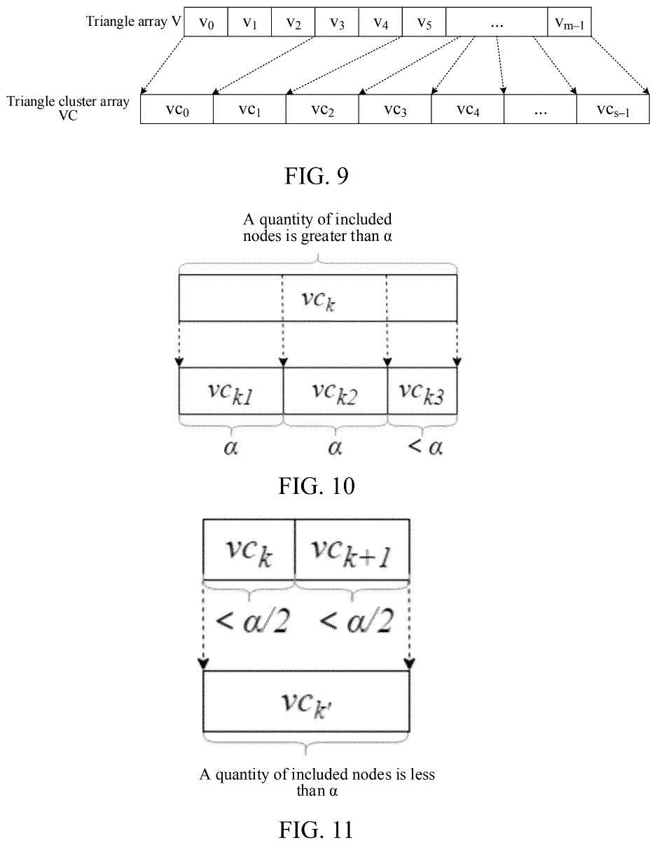

Operation S2: Cluster and group the triangles. For example, FIG. 9 is a schematic diagram showing clustering of triangles according to an embodiment of this application. As shown in FIG. 9, an array V is traversed, bone association information VB is queried, and a node vᵢ and a node vᵢ₊₁ that are adjacent in the array V are traversed. Whether bone information Bᵢ and bone information Bᵢ₊₁ associated with the node vᵢ and the node vᵢ₊₁ are the same is determined. If Bᵢ and Bᵢ₊₁ are exactly the same, the node vᵢand the node vᵢ₊₁ are grouped into the same triangle cluster vcₖ. Otherwise, whether traversing of the nodes in V ends is determined. If the traversing does not end, grouping nodes into a next triangle cluster vcₖ₊₁ is performed from vᵢ₊₁. After all vertexes are sequentially processed in the foregoing manner, s triangle clusters are obtained.

Apparently, s is less than or equal to m. After grouping, a triangle cluster array is obtained and is denoted as VC, where VC={vcₖ, k=0, 1, . . . , s−1}.

Operation S3: Split a large triangle cluster for optimization. For example, FIG. 10 is a schematic diagram showing splitting optimization of a large triangle cluster according to this application. As shown in FIG. 10, for the grouped triangle cluster array VC, a constant α is specified, vcₖ in the array VC is traversed, and determination is performed sequentially. If a quantity of nodes in vcₖ exceeds α, vcₖ is further split based on a value of α. After splitting, a quantity of triangles in each vcₖ does not exceed α. Then, whether traversing of nodes in VC ends is determined. If the traversing does not end, a next vcₖ is traversed. After all nodes are traversed, a new triangle cluster array VC is obtained. In an actual algorithm, based on a system parameter, α may be set to 192, or may be set to another value.

Splitting the large triangle cluster into small triangles has the following effects.

\textcircled{1} The quantity α of triangles is a quantity obtained after actual measurement that is conducive to rendering.

\textcircled{2} After the splitting, a bounding box is smaller, which is conducive to accuracy of clipping.

Operation S4: Combine small triangle clusters for optimization. For example, FIG. 11 is a schematic diagram showing combination optimization of small triangle clusters according to this application. As shown in FIG. 11, for a split triangle cluster array VC, vcₖ in the array VC is traversed and determining is performed sequentially, to be specific, whether a quantity of nodes in vcₖ and a quantity of nodes in vcₖ₊₁ are both less than α/2 is determined.

Specifically, for example, if the quantity of nodes in vcₖ is less than α/2, whether the quantity of nodes in adjacent vcₖ₊₁ is also less than α/2 is determined. If yes, vcₖ and vcₖ₊₁ are clustered into a new triangle cluster, and then whether traversing of the nodes in VC ends is determined. If the traversing of the nodes in VC does not end, a next vcₖ is traversed until a quantity of nodes included in each vcₖ is between α/2 and α. So far, computation of the triangle cluster array VC is completed, and a quantity of vcs included in the triangle cluster array VC is represented by s′, and VC={vcₖ, k=0, 1, . . . , s′−1}.

Operation S5: Compute a dynamic bounding box of a triangle cluster. Suppose a total quantity of frames of a character action is n. For each triangle cluster vcₖ in the triangle cluster array VC, a single-frame bounding box of an i^{th} frame of action of vcₖ is computed for i=0, 1, . . . , n−1 (that is, a single-frame bounding box of each frame of action is computed), where the single-frame bounding box is denoted as b_vcₖᵢ. Then, single-frame bounding boxes are summed to obtain the dynamic bounding box, and the vcₖ dynamic bounding box b_vcₖ=Σi=0, 1, . . . , n−1b_vcₖᵢ. In this algorithm, an AABB algorithm may be used, where two points are configured for representing: Pₘᵢₙ=[Xₘᵢₙ, Yₘᵢₙ, Zₘᵢₙ], and Pₘₐₓ=[Xₘₐₓ, Yₘₐₓ, Zₘₐₓ]. Therefore, b_vcₖᵢ=(Pminₖᵢ, Pmaxₖᵢ). An AABB sum may be computed by adding a vertex to the bounding box, that is, b_vcₖᵢ+b_vcₖⱼ=add (add (b_vcₖᵢ, Pminₖⱼ), Pmaxₖⱼ). An add function is a general algorithm of adding a vertex to the AABB. After all computations are completed, bounding box data B_VC of all triangle clusters is obtained, where B_VC={b_vcₖ, k=0, 1, . . . , s′−1}. The offline computation is completed.

Combining small triangle clusters has the following two effects.

\textcircled{1} Impact on clipping performance caused because a quantity of clusters is excessively large can be avoided.

\textcircled{2} The small triangle clusters are not conducive to GPU concurrent running during actual rendering, and the combined triangle cluster is more conducive to GPU concurrent running during actual rendering.

Finally, the computer device stores the triangle cluster array VC, and the bounding box data B_VC of all triangle clusters.

### 2. Runtime Processing Process

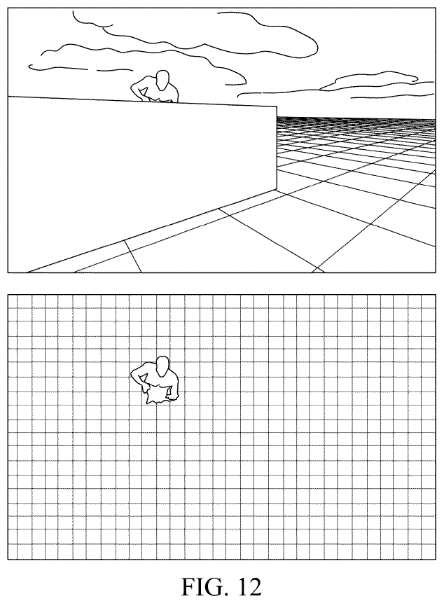

In the runtime processing process, clipping and culling are performed and actual submission is performed for rendering based on an offline pre-computed triangle cluster array VC and corresponding dynamic bounding box B_VC information. FIG. 12 is a diagram showing an occlusion clipping effect according to this application. After a character is occluded by a scene object and is clipped, a remaining area that needs to be submitted for rendering is shown in FIG. 12.

As shown in FIG. 6, an algorithm process of the runtime processing is described as follows:

Operation S1: Clip a character instance: A position of the character may not be within a displayable range of a screen, so that performance waste may be caused if computing and submission for rendering are performed for all characters. Therefore, clipping and culling at a character instance level are first performed on a ComputeShader (compute shader) computation unit of a GPU. A character that is not within the displayable range is removed at the character instance level based on a viewing frustum clipping algorithm and a hierarchical Z-buffer (HZB) clipping algorithm.

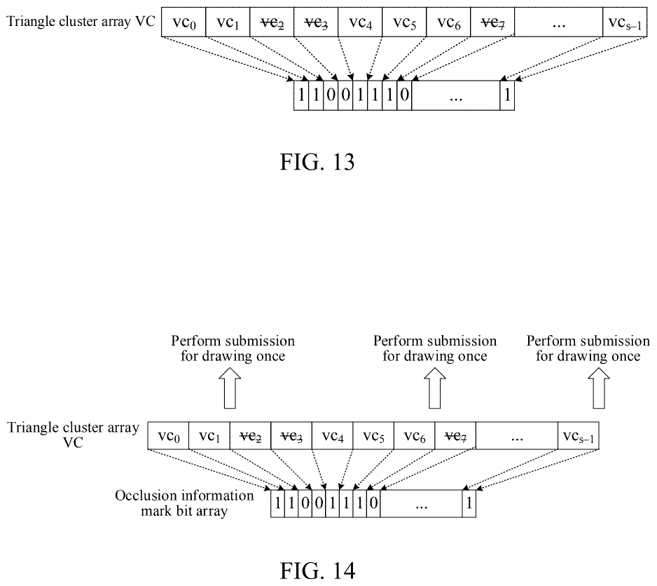

Operation S2: Clip at a triangle cluster level: For each vcₖ in VC, read B_VC corresponding to an index, to obtain vcₖ dynamic bounding box data b_vcₖ. Similarly, a situation of occlusion of each vcₖ is computed on the ComputeShader computation unit of the GPU by using the viewing frustum clipping algorithm and the HZB clipping algorithm, to determine whether vcₖ is occluded. If b_vcₖ is occluded by another area or a scene object, rendering is not needed. FIG. 13 is a schematic diagram showing an occlusion mark according to this application. As shown in FIG. 13, in this embodiment of this application, an occlusion information mark bit array may be used to store information about whether all triangle clusters need to be drawn, where 1 indicates that rendering is needed, and 0 indicates that rendering is not needed. In other words, if vcₖ is occluded, a corresponding bit is set to 0. Otherwise, the corresponding bit is set to 1.

Operation S3: Submit the triangle clusters in batches for rendering: Combine, based on information in the bit array in operation S2, adjacent vcs that need to be rendered, and submit vertexes of the combined vc in batches through a medium dependent interface (MDI) of a system, to perform rendering processing. FIG. 14 shows batch submission for rendering according to this application. As shown in FIG. 14, vc₀ and vc₁ are adjacent and need to be submitted, so that vc₀ and vc₁ are submitted in the same DrawCall. vc₄ to vc₆ are adjacent, but are not adjacent to vc₀ and vc₁, so that vc₄ to vc₆ are submitted in a next DrawCall, and so on.

In this embodiment of this application, a clustering algorithm currently used for the offline generation part is the triangle cluster generation based on bone algorithm, to be specific, only one triangle cluster result is generated for one character model based on bone information in the foregoing algorithm. In addition, offline generation may also be implemented by using a cluster generation based on animation algorithm, to be specific, if a character model has a plurality of actions, a respective triangle cluster result is generated for each action of the character model. In this way, more offline computation results need to be stored, but a more accurate culling result is obtained during subsequent runtime occlusion culling computation.

In addition, for the computation of the dynamic bounding box of the triangle cluster in operation S5 in the offline generation part, in this embodiment of this application, AABB computation is used, or another bounding box computation method may be used, for example, a bounding sphere, an oriented bounding box (OBB), or a fixed direction hull (FDH).

For the submitting of the triangle clusters in batches for rendering in operation S3 in the runtime part, combining for batch submission for rendering is performed based on the occlusion information mark bit array of this algorithm. In addition, the combining for submission may be performed in a manner of invoking a system wave interface.

According to the solutions shown in the foregoing embodiments of this application, a technical solution of large-scale character real-time rendering driven by a GPU is provided. An overall solution framework includes two parts: offline pre-computation and runtime processing. First, for a character action, character triangle cluster information and dynamic bounding box information of the triangle cluster are pre-computed offline and saved. Then, during running, clipping and culling at an instance level and a triangle cluster level are performed on massive dynamic characters based on a computing capability of the GPU. Finally, the DrawCall is integrated and submitted for rendering, to complete the entire rendering process. In this technical solution, friendliness of a vertex cache to a hardware VertexCache is fully considered during offline computation, the computing capacity of the GPU is fully utilized in runtime computation, rendering information is simplified, and submission is performed in batches for rendering, to reduce DrawCall overheads. In this way, rendering requirements on large-scale and massive dynamic characters in the same scene and on the same screen are meet, a performance bottleneck problem is resolved, and performance indicators like a high frame rate are achieved.

Specifically, the solutions shown in the foregoing embodiments of this application may be applied to an application scene in which large-scale and massive dynamic characters need to be displayed on the same screen at the same time in a game scenario, and can ensure performance and experience of a high frame rate and smoothness without frame freezing, to present good game performance.

In comparison with a hardware instantiation solution, in a large-scale character rendering scenario in which 5,000 characters are on the same screen and each character has 7,000 faces, performance of the solutions shown in this embodiment of this application is significantly improved. Details are as follows:
(1) On a graphics card of a specific model, in comparison with the hardware instantiation solution, in this solution:
time consumption is decreased from 6.63 ms to 2.3 ms, which is decreased by 61%;
triangle vertex workload is decreased by 63%;
L2 utilization is increased from 23% to 41%;
use efficiency of a shader is increased from 66% to 73%; and
a hit rate of a texture L1 cache is decreased from 94% to 80%, but a hit rate of an L2 cache is increased from 82% to 96%.
(2) On a graphics card of another model, in comparison with the hardware instantiation solution, in this solution:
time consumption is decreased from 4.65 ms to 2.7 ms, which is decreased by 42%;
triangle vertex workload is decreased by 58%;
L2 utilization is basically stable, fluctuating from 46% to 43%;
use efficiency of a shader is basically stable, fluctuating from 63% to 60%;
a hit rate of a texture L1 cache is basically stable, fluctuating from 70% to 72%; and a high hit rate of an L2 cache is also maintained, fluctuating from 99.3% to 98%.

In conclusion, it can be learned from comparison of experimental data of different graphics cards that the algorithm provided in this embodiment of this application can significantly reduce time consumption of a single frame, significantly reduce triangle vertex workload, and maintain or improve to some extent L2 utilization, use efficiency of a shader, and a hit rate of a cache stable.

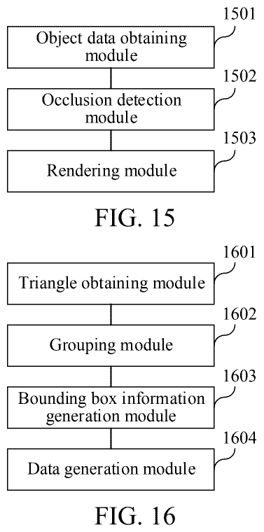

FIG. 15 shows a block diagram of a data processing apparatus according to an exemplary embodiment of this application. The apparatus includes:
an object data obtaining module 1501, configured to obtain object data of a virtual object in a virtual scene, the object data indicating a plurality of triangle groups of the virtual object, bounding box information of the triangle groups, and a triangle group that is completely unoccluded, and the bounding box information indicating a coordinate position of a bounding box of the triangle group;
an occlusion detection module 1502, configured to perform occlusion detection on bounding boxes of the plurality of triangle groups based on the object data, to determine one or more unoccluded triangle groups; and
a rendering module 1503, configured to perform rendering processing on the one or more unoccluded triangle groups, to obtain a scene image of the virtual scene.

In some embodiments, triangles included in the triangle group are triangles that are adjacent after sorting based on a specified sorting algorithm. The specified sorting algorithm is an algorithm of sorting triangles of an object model with a target of optimizing a vertex cache.

The rendering module 1503 is configured to:
combine, when there are a plurality of unoccluded triangle groups, triangle groups that include adjacent triangles in the plurality of unoccluded triangle groups, to obtain a combined triangle group; and
when there are a plurality of combined triangle groups, sequentially submit, in an arrangement order of triangles included in the plurality of combined triangle groups, the plurality of combined triangle groups for rendering, to obtain the scene image of the virtual scene.

In some embodiments, one triangle is bound to one or more bones in the object model, the virtual object has one or more action states, and the bounding box corresponding to the triangle group is a single bounding box of the triangle group in all action states of the virtual object.

In some embodiments, one triangle is bound to one or more bones in the object model, the virtual object has one or more action states, and the bounding box corresponding to the triangle group includes a bounding box respectively corresponding to the triangle group in the one or more action states of the virtual object.

The occlusion detection module 1502 is configured to perform, based on the object data, occlusion detection on the bounding boxes respectively corresponding to the plurality of triangle groups in a current action state of the virtual object, to determine the one or more unoccluded triangle groups.

FIG. 16 shows a block diagram of a data processing apparatus according to an exemplary embodiment of this application. The apparatus includes:
a triangle obtaining module 1601, configured to obtain triangles on a surface of an object model of a virtual object;
a grouping module 1602, configured to group the triangles on the surface of the object model into a plurality of triangle groups;
a bounding box information generation module 1603, configured to generate bounding box information of the triangle group, the bounding box information indicating a coordinate position of a bounding box of the triangle group; and
a data generation module 1604, configured to generate object data of the virtual object based on the plurality of triangle groups and the bounding box information of the triangle groups,
the object data being used by a display device to perform occlusion detection on bounding boxes of the plurality of triangle groups, to determine one or more unoccluded triangle groups, and perform rendering processing on the one or more unoccluded triangle groups, to obtain a scene image of a virtual scene.

In some embodiments, the grouping module 1602 is configured to:
sort the triangles on the surface of the object model based on a specified sorting algorithm, the specified sorting algorithm being an algorithm of sorting the triangles in the object model with a target of optimizing a vertex cache; and
group the triangles on the surface of the object model into the plurality of triangle groups based on an arrangement order of the triangles on the surface of the object model, the triangle groups including triangles that are adjacent after sorting.

In some embodiments, one triangle is bound to one or more bones in the object model.

The grouping module 1602 is configured to:
group the triangles on the surface of the object model into a plurality of candidate triangle groups based on the arrangement order of the triangles on the surface of the object model and the bones bound to the triangles on the surface of the object model; and
perform specified processing on the plurality of candidate triangle groups, to obtain the plurality of triangle groups, the specified processing including at least one of combining processing or splitting processing.

In some embodiments, the grouping module 1602 is configured to:
obtain bones respectively bound to a first triangle and a second triangle, the first triangle and the second triangle being two triangles adjacent in the arrangement order in the triangles on the surface of the object model; and
add the first triangle and the second triangle to the same candidate triangle group when the bones respectively bound to the first triangle and the second triangle are the same.

In some embodiments, the grouping module 1602 is configured to:
divide a first candidate triangle group into two or more triangle groups when a quantity of triangles included in the first candidate triangle group is greater than a quantity threshold, the first candidate triangle group being one of the plurality of candidate triangle groups, and a quantity of triangles included in the triangle group being not greater than the quantity threshold; and
combine a second candidate triangle group and a third candidate triangle group when a sum of a quantity of triangles included in the second candidate triangle group and a quantity of triangles included in the third candidate triangle group is not greater than the quantity threshold, the second candidate triangle group and the third candidate triangle group being adjacent groups in the plurality of candidate triangle groups.

In some embodiments, the virtual object has one or more action states.

The bounding box information generation module 1603 is configured to:
generate a single piece of bounding box information of the triangle group in all action states of the virtual object; or
generate bounding box information respectively corresponding to the triangle group in the one or more action states of the virtual object.

When the apparatus provided in the foregoing embodiments implements functions of the apparatus, division of the foregoing functional modules is merely used as an example for description. In an actual application, the foregoing functions may be allocated to and completed by different functional modules according to actual requirements, that is, a content structure of a device is divided into different functional modules, to complete all or some of the functions described above.

Specific manners in which the modules in the apparatus in the foregoing embodiments perform operations have been described in detail in the embodiments related to the method. Technical effects obtained by performing operations by the modules are the same as the technical effects in the embodiments related to the method. Details are not described herein again.

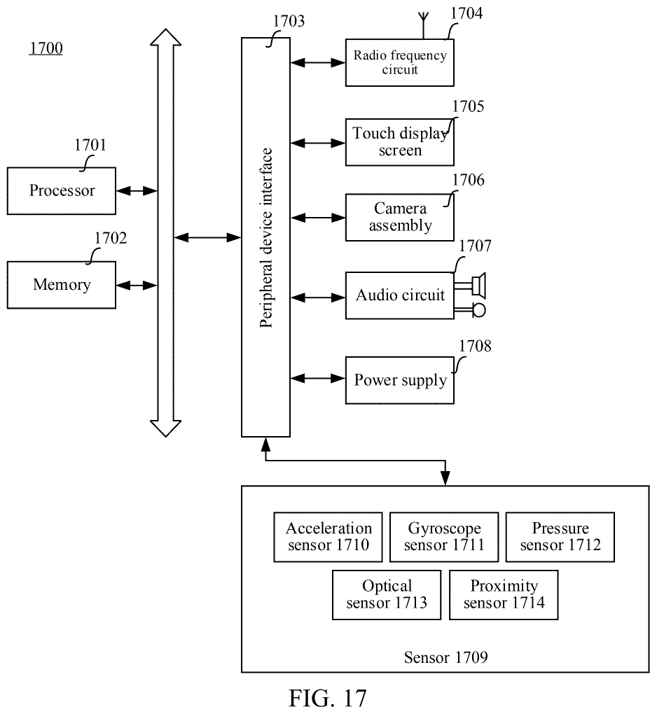

FIG. 17 shows a structural block diagram of a computer device 1700 according to an exemplary embodiment of this application. The computer device 1700 may be a portable mobile terminal, such as a smartphone and a tablet computer. The computer device 1700 may be further referred to as another name such as user equipment or a portable terminal.

Generally, the computer device 1700 includes a processor 1701 and a memory 1702.

The processor 1701 may include one or more processing cores, such as a 4-core processor or an 8-core processor. The processor 1701 may be implemented in at least one hardware form of digital signal processing (DSP), a field programmable gate array (FPGA), and a programmable logic array (PLA). The processor 1701 may also include a main processor and a coprocessor. The main processor is configured to process data in an active state, and is also referred to as a central processing unit (CPU). The coprocessor is a low-power consumption processor configured to process data in a standby state. In some embodiments, the processor 1701 may be integrated with a graphics processing unit (GPU). The GPU is configured to be responsible for rendering and drawing content that needs to be displayed on a display screen. In some embodiments, the processor 1701 may further include an artificial intelligence (AI) processor. The AI processor is configured to process computing operations related to machine learning.

The memory 1702 may include one or more computer-readable storage media. The computer-readable storage medium may be tangible and non-transient. The memory 1702 may further include a high-speed random access memory and a non-volatile memory, for example, one or more disk storage devices and flash storage devices. In some embodiments, the non-transient computer-readable storage medium in the memory 1702 is configured to store at least one computer instruction. The at least one computer instruction is loaded and executed by the processor 1701 to implement the data processing method provided in the embodiments of this application.

In some embodiments, the computer device 1700 may further include, for example, a peripheral device interface 1703 and at least one peripheral device. Specifically, the peripheral device includes at least one of a radio frequency circuit 1704, a touch display screen 1705, a camera assembly 1706, an audio circuit 1707, or a power supply 1708.

In some embodiments, the computer device 1700 further includes one or more sensors 1709. The one or more sensors 1709 include, but are not limited to, an acceleration sensor 1710, a gyroscope sensor 1711, a pressure sensor 1712, an optical sensor 1713, and a proximity sensor 1714.

A person skilled in the art may understand that the structure shown in the foregoing does not constitute a limitation on the computer device 1700, and the computer device 1700 may include more components or fewer components than those shown in the figure, or some components may be combined, or a different component deployment may be used.

In an exemplary embodiment, a chip is further provided. The chip includes a programmable logic circuit and/or program instructions. When running on a computer device, the chip is configured to implement the data processing method according to the foregoing aspects.

In an exemplary embodiment, a computer program product is further provided. The computer program product includes computer instructions, and the computer instructions are stored in a computer-readable storage medium. The computer instructions are read and executed by a processor of a computer device, to implement the data processing method provided in the foregoing method embodiments.

In an exemplary embodiment, a computer-readable storage medium is further provided, the computer-readable storage medium having computer instructions stored therein, and the computer instructions being loaded and executed by a processor to implement the data processing method provided in the foregoing method embodiments.

What is claimed is:

1. A data processing method, performed by a computer device, comprising:
obtaining object data of a virtual object in a virtual scene, the object data indicating a plurality of triangle groups of the virtual object and bounding box information of the triangle groups, the plurality of triangle groups being obtained by grouping triangles on a surface of an object model of the virtual object, and the bounding box information indicating coordinate positions of bounding boxes of the plurality of triangle groups;
performing occlusion detection on the bounding boxes based on the object data, to determine one or more unoccluded triangle groups; and
performing rendering processing on the one or more unoccluded triangle groups, to obtain a scene image of the virtual scene.

2. The method according to claim 1, wherein:
triangles in each of the plurality of triangle groups are adjacent triangles after sorting based on a specified sorting algorithm that sorts the triangles in the object model with a target of optimizing a vertex cache;
the one or more unoccluded triangle groups include a plurality of unoccluded triangle groups; and
performing rendering processing on the plurality of unoccluded triangle groups includes:
combining ones of the plurality of unoccluded triangle groups, to obtain one or more combined triangle groups.

3. The method according to claim 2, wherein:
the one or more combined triangle groups include a plurality of combined triangle groups; and
performing rendering processing on the plurality of unoccluded triangle groups further includes:
sequentially submitting, based on an arrangement order of triangles in the plurality of combined triangle groups, the plurality of combined triangle groups for rendering, to obtain the scene image of the virtual scene.

4. The method according to claim 1, wherein one triangle is bound to one or more bones in the object model, the virtual object has one or more action states, and the bounding box corresponding to one triangle group is a single bounding box of the one triangle group in all action states of the virtual object.

5. The method according to claim 1, wherein:
one triangle is bound to one or more bones in the object model, the virtual object has one or more action states, and the bounding box corresponding to one triangle group includes one or more bounding boxes, corresponding to the one triangle group, in the one or more action states, respectively, of the virtual object; and
performing occlusion detection on the bounding boxes includes:
performing, based on the object data, occlusion detection on the bounding boxes respectively corresponding to the plurality of triangle groups in a current action state of the virtual object, to determine the one or more unoccluded triangle groups.

6. A non-transitory computer-readable storage medium storing at least one computer instruction that, when executed by a processor, causes a computer device including the processor to perform the method according to claim 1.

7. A computer device comprising:
a processor; and
a memory storing at least one computer instruction that, when executed by the processor, causes the computer device to:
obtain object data of a virtual object in a virtual scene, the object data indicating a plurality of triangle groups of the virtual object and bounding box information of the triangle groups, the plurality of triangle groups being obtained by grouping triangles on a surface of an object model of the virtual object, and the bounding box information indicating coordinate positions of bounding boxes of the plurality of triangle groups;
perform occlusion detection on the bounding boxes based on the object data, to determine one or more unoccluded triangle groups; and
perform rendering processing on the one or more unoccluded triangle groups, to obtain a scene image of the virtual scene.

8. The computer device according to claim 7, wherein:
triangles in each of the plurality of triangle groups are adjacent triangles after sorting based on a specified sorting algorithm that sorts the triangles in the object model with a target of optimizing a vertex cache;
the one or more unoccluded triangle groups include a plurality of unoccluded triangle groups; and
the at least one computer instruction, when executed by the processor, further causes the computer device to, when performing rendering processing on the plurality of unoccluded triangle groups:
combine ones of the plurality of unoccluded triangle groups, to obtain one or more combined triangle groups.

9. The computer device according to claim 8, wherein:
the one or more combined triangle groups include a plurality of combined triangle groups; and
the at least one computer instruction, when executed by the processor, further causes the computer device to, when performing rendering processing on the plurality of unoccluded triangle groups:
sequentially submit, based on an arrangement order of triangles in the plurality of combined triangle groups, the plurality of combined triangle groups for rendering, to obtain the scene image of the virtual scene.

10. The computer device according to claim 7, wherein one triangle is bound to one or more bones in the object model, the virtual object has one or more action states, and the bounding box corresponding to one triangle group is a single bounding box of the one triangle group in all action states of the virtual object.

11. The computer device according to claim 7, wherein:
one triangle is bound to one or more bones in the object model, the virtual object has one or more action states, and the bounding box corresponding to one triangle group includes one or more bounding boxes, corresponding to the one triangle group, in the one or more action states, respectively, of the virtual object; and
the at least one computer instruction, when executed by the processor, further causes the computer device to, when performing occlusion detection on the bounding boxes:
perform, based on the object data, occlusion detection on the bounding boxes respectively corresponding to the plurality of triangle groups in a current action state of the virtual object, to determine the one or more unoccluded triangle groups.

12. A data processing method comprising:
obtaining triangles on a surface of an object model of a virtual object;
grouping the triangles into a plurality of triangle groups;
generating bounding box information of the plurality of triangle groups, the bounding box information indicating coordinate positions of bounding boxes of the plurality of triangle groups; and
generating object data of the virtual object based on the plurality of triangle groups and the bounding box information, to be used by a display device to perform occlusion detection on the bounding boxes to determine one or more unoccluded triangle groups and perform rendering processing on the one or more unoccluded triangle groups to obtain a scene image of a virtual scene.

13. The method according to claim 12, wherein grouping the triangles includes:
sorting the triangles based on a specified sorting algorithm with a target of optimizing a vertex cache; and
grouping the triangles based on an arrangement order of the triangles, each of the plurality of triangle groups including triangles that are adjacent triangles after sorting.

14. The method according to claim 13, wherein:
one triangle is bound to one or more bones in the object model; and
grouping the triangles based on the arrangement order includes:
grouping the triangles into a plurality of candidate triangle groups based on the arrangement order and bones bound to the triangles; and
performing specified processing on the plurality of candidate triangle groups, to obtain the plurality of triangle groups, the specified processing including at least one of combining processing or splitting processing.

15. The method according to claim 14, wherein grouping the triangles based on the arrangement order and the bones includes:
obtaining bones respectively bound to a first triangle and a second triangle, the first triangle and the second triangle being two triangles adjacent to each other in the arrangement order among the triangles on the surface of the object model; and
adding the first triangle and the second triangle to a same candidate triangle group in response to the bones respectively bound to the first triangle and the second triangle being same.

16. The method according to claim 14, wherein:
a quantity of triangles in one candidate triangle group of the plurality of candidate triangle groups is greater than a quantity threshold; and
performing the specified processing on the plurality of candidate triangle groups includes:
dividing the one candidate triangle group into two or more triangle groups, a quantity of triangles in each of the two or more triangle groups being not greater than the quantity threshold.

17. The method according to claim 14, wherein:
a sum of quantities of triangles in two adjacent candidate triangle groups of the plurality of candidate triangle groups is not greater than a quantity threshold; and
performing the specified processing on the plurality of candidate triangle groups includes:
combining the two adjacent candidate triangle groups.

18. The method according to claim 12, wherein:
the virtual object has one or more action states; and
generating the bounding box information includes, for one triangle group of the plurality of triangle groups:
generating a single piece of bounding box information of the one triangle group in all of the one or more action states of the virtual object; or
generating bounding box information corresponding to the one triangle group respectively in the one or more action states of the virtual object.

19. A computer device comprising:
a processor; and
a memory storing at least one computer instruction that, when executed by the processor, causes the computer device to perform the method according to claim 12.

20. A non-transitory computer-readable storage medium storing at least one computer instruction that, when executed by a processor, causes a computer device including the processor to perform the method according to claim 12.
